(19) United States
(12) Patent Application Publication
(10) Pub. No.: US 2010/0080380 A1
(43) Pub. Date: Apr. 1, 2010

(54) Method and Apparatus for Supplying DC Feed to a Subscriber Line

(76) Inventors: Yan Zhou, Austin, TX (US); Ion C. Tesu, Austin, TX (US); Shuang Pan, Austin, TX (US)

Correspondence Address: DAVIS & ASSOCIATES, P.O. BOX 1093, DRIPPING SPRINGS, TX, 78620, US

(21) Appl. No.: 12/242,574

(22) Filed: Sep. 30, 2008

(51) Int. Cl. H04M 9/00

(52) U.S. Cl. 379/413

(57) ABSTRACT

A subscriber line apparatus including linefeed driver circuitry for providing a DC feed for a tip line and a ring line of the subscriber line from a power supply in accordance with linefeed driver control signals. Bypass circuitry couples the tip and ring lines to the power supply in accordance with a power mode control. The tip and ring lines are coupled to the power supply through the linefeed driver circuitry in a first power mode. The linefeed driver circuitry is bypassed to couple the tip and ring lines to the power supply in a second power mode.

### BACKGROUND

Subscriber line interface circuits are typically found in the central office exchange of a telecommunications network. A subscriber line interface circuit (SLIC) provides a communications interface between the digital switching network of a central office and an analog subscriber line. The analog subscriber line connects to a subscriber station or telephone instrument at a location remote from the central office exchange.

The analog subscriber line and subscriber equipment form a subscriber loop. The interface requirements of a SLIC result in the need to provide relatively high voltages and currents for control signaling with respect to the subscriber equipment on the subscriber loop. Voiceband communications are low voltage analog signals on the subscriber loop. Thus the SLIC must detect and transform low voltage analog signals into digital data for transmitting communications received from the subscriber equipment to the digital network. For bi-directional communication, the SLIC must also transform digital data received from the digital network into low voltage analog signals for transmission on the subscriber loop to the subscriber equipment.

A subscriber line interface circuit requires different power supply levels depending upon operational state. One supply level is required when the subscriber equipment is “on-hook” and another supply level is required when the subscriber equipment is “off-hook”. Another supply level may be required for “ringing”.

The SLIC must be provided with a voltage supply sufficient to accommodate the most negative loop voltage while maintaining the SLIC internal circuitry in their normal region of operation. In order to ensure sufficient supply levels, a power supply providing a constant or fixed supply level sufficient to meet or exceed the requirements of all of these states may be provided. The use of a single fixed power supply tends to result in unnecessary power dissipation.

Another solution is to utilize a variable power supply. The overhead associated with sensing and controlling the variable power supply and subscriber line DC feed is insubstantial compared to the power utilized when the subscriber equipment is in the off-hook state. Once the same sensing and control mechanisms are applied to the on-hook state, however, the overhead associated with sensing and controlling the variable power supply and DC feed becomes a significant component of the total power utilized when in the on-hook state. The power efficiencies gained during the off-hook state are lost in the on-hook state.

### SUMMARY

A subscriber line apparatus includes linefeed driver circuitry for providing a DC feed for a tip line and a ring line of the subscriber line from a power supply in accordance with linefeed driver control signals. Bypass circuitry couples the tip and ring lines to the power supply in accordance with a power mode control. The tip and ring lines are coupled to the power supply through the linefeed driver circuitry in a first power mode. The linefeed driver circuitry is bypassed to couple the tip and ring lines to the power supply in a second power mode.

A method includes utilizing a first power mode for a linefeed driver of a subscriber line interface circuit while in an off-hook state, wherein the linefeed driver supplies a DC feed to the subscriber line in accordance with linefeed driver control signals. A second power mode is utilized for the linefeed driver while in an on-hook state, if a duration of the on-hook state exceeds a pre-determined threshold of time, wherein the power supply supplies the DC feed to the subscriber line independent of the linefeed driver control signals.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates one embodiment of a subscriber line interface circuit including a signal processor and a linefeed driver.

FIG. 2 illustrates one embodiment of a DC feed curve.

FIG. 3 illustrates one embodiment of a method of providing DC feed to a subscriber line.

FIG. 4 illustrates one embodiment of a linefeed driver with bypass circuitry for supporting multiple power modes.

FIG. 5 illustrates one embodiment of a communication spectrum allocation for a subscriber line.

FIG. 6 illustrates one embodiment of a method of providing DC feed to a subscriber line.

FIG. 7 illustrates one embodiment of a method of transitioning between power modes.

### DETAILED DESCRIPTION

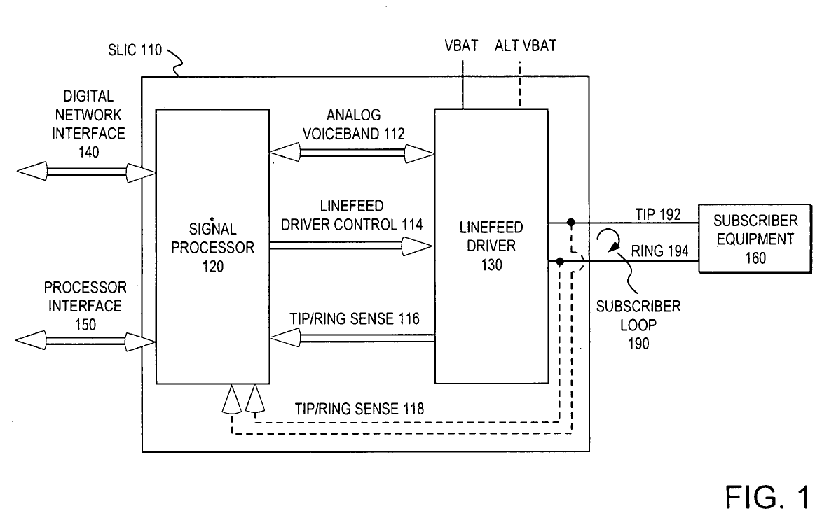

FIG. 1 illustrates one embodiment of a subscriber line interface circuit 110 associated with plain old telephone services (POTS) telephone lines. The subscriber line interface circuit (SLIC) provides an interface between a digital switching network of a local telephone company central exchange and a subscriber line comprising a tip 192 and a ring 194 line. A subscriber loop 190 is formed when the subscriber line is coupled to subscriber equipment 160 such as a telephone.

The subscriber loop 190 communicates analog data signals (e.g., voiceband communications) as well as subscriber loop “handshaking” or control signals. The subscriber loop state is often specified in terms of the tip 192 and ring 194 portions of the subscriber loop.

The SLIC is typically expected to perform a number of functions often collectively referred to as the BORSCHT requirements. BORSCHT is an acronym for “battery feed,” “overvoltage protection,” “ringing,” “supervision,” “codec,” “hybrid,” and “test.” The term “linefeed” will be used interchangeably with “battery feed”. Modern SLICs may have battery backup, but the supply to the subscriber line is typically not actually provided by a battery despite the retention of the term “battery” to describe the supply (e.g., VBAT).

The ringing function, for example, enables the SLIC to signal the subscriber equipment 160. In one embodiment, subscriber equipment 160 is a telephone. Thus, the ringing function enables the SLIC to ring the telephone.

In the illustrated embodiment, the BORSCHT functions are distributed between a signal processor 120 and a linefeed driver 130. The signal processor and linefeed driver typically reside on a linecard (110) to facilitate installation, maintenance, and repair at a central exchange. Signal processor 120 is responsible for at least the ringing control, supervision, codec, and hybrid functions. Signal processor 120 controls and interprets the large signal subscriber loop control signals as well as handling the small signal analog voiceband data and the digital voiceband data.

In one embodiment, signal processor 120 is an integrated circuit. The integrated circuit includes sense inputs for both a sensed tip and a sensed ring signal of the subscriber loop. The integrated circuit generates subscriber loop linefeed driver control signal in response to the sensed signals. The signal processor has relatively low power requirements and can be implemented in a low voltage integrated circuit operating in the range of approximately 5 volts or less. In one embodiment, the signal processor is fabricated as a complementary metal oxide semiconductor (CMOS) integrated circuit.

Signal processor 120 receives subscriber loop state information from linefeed driver 130 as indicated by tip/ring sense 116. The signal processor may alternatively directly sense the tip and ring as indicated by tip/ring sense 118. This information is used to generate linefeed driver control 114 signals for linefeed driver 130. Analog voiceband 112 data is bi-directionally communicated between linefeed driver 130 and signal processor 120. In an alternative embodiment, analog voiceband signals are communicated downstream to the subscriber equipment via the linefeed driver but upstream analog voiceband signals are extracted from the tip/ring sense 118.

SLIC 110 includes a digital network interface 140 for communicating digitized voiceband data to the digital switching network of the public switched telephone network (PSTN). The SLIC may also include a processor interface 150 to enable programmatic control of the signal processor 120. The processor interface effectively enables programmatic or dynamic control of battery control, battery feed state control, voiceband data amplification and level shifting, longitudinal balance, ringing currents, and other subscriber loop control parameters as well as setting thresholds including ring trip detection and off-hook detection threshold.

Linefeed driver 130 maintains responsibility for battery feed to tip 192 and ring 194. The battery feed and supervision circuitry typically operate in the range of 40-75 volts. The battery feed is negative with respect to ground, however. Moreover, although there may be some crossover, the maximum and minimum voltages utilized in the operation of the battery feed and supervision circuitry (−48 or less to 0 volts) tend to define a range that is substantially distinct from the operational range of the signal processor (e.g., 0-5 volts). In some implementations the ringing function is handled by the same circuitry as the battery feed and supervision circuitry. In other implementations, the ringing function is performed by separate higher voltage ringing circuitry (75-150 Vrms).

Linefeed driver 130 modifies the large signal tip and ring operating conditions in response to linefeed driver control 114 provided by signal processor 120. This arrangement enables the signal processor to perform processing as needed to handle the majority of the BORSCHT functions. For example, the supervisory functions of ring trip, ground key, and off-hook detection can be determined by signal processor 120 based on operating parameters provided by tip/ring sense 116.

The linefeed driver receives a linefeed supply VBAT for driving the subscriber line for SLIC “on-hook” and “off-hook” operational states. An alternate linefeed supply (ALT VBAT) may be provided to handle the higher voltage levels (75-150 Vrms) associated with ringing.

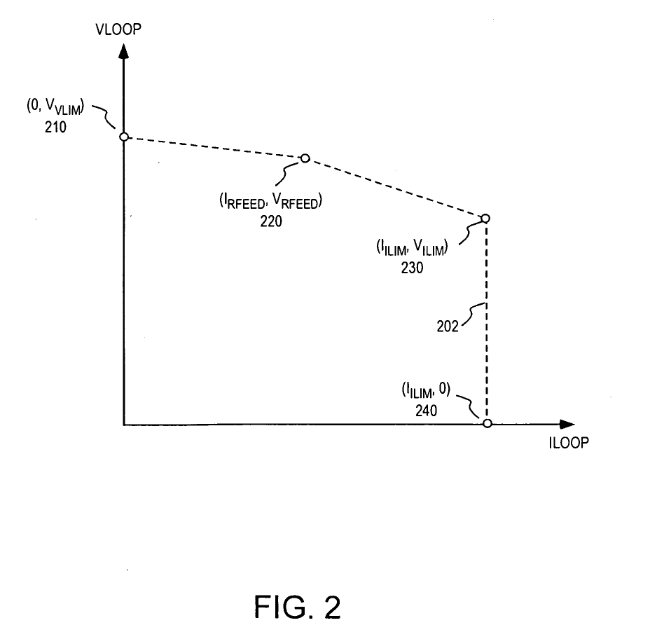

FIG. 2 illustrates one embodiment of a SLIC DC feed curve 202. The term “curve” is not intended to be limited to non-linear shaped feed characteristics, but rather is used to describe a collection of points defining a path. Thus, for example, the DC feed curve may be decomposed into piecemeal segments that may be defined by various polynomial functions. One or more segments may be line segments, for example.

The DC feed curve is expressed in terms of loop voltage (V_{LOOP}) and current (I_{LOOP}). The SLIC controls the subscriber loop DC feed to follow the curve. The operating point along the curve is determined by the subscriber loop load. In one embodiment, the curve includes three segments defining three regions of operation: constant voltage, resistive feed, and current limited.

The constant voltage region extends from point 210 to point 220. The subscriber equipment may be considered “on-hook” in this region. Point 210 is defined by the co-ordinates (0, V_{VLIM}). The resistive feed region exists between points 220 and 230. Point 220 is defined by the co-ordinate (I_{RFEED}, V_{RFEED}). The current limit region exists between points 230 and 240. The current is not permitted to exceed this limit. The subscriber equipment may be considered off-hook in both the resistive feed and current limit regions. Point 230 is defined by the co-ordinates (I_{ILIM}, V_{ILIM}). Point 240 is defined by the co-ordinate (I_{ILIM}m 0). Parameters V_{VLIM}, I_{RFEED}, V_{RFEED}, I_{ILIM}, and V_{ILIM} may be programmable to permit adjustment to accommodate environmental constraints such as the available battery, loop length, or other constraint. These parameters may be provided via the processor interface 150 and stored, for example, within a register or other memory of the signal processor.

The sensing and computational resources utilized for controlling the linefeed driver to provide the DC feed consume an insignificant portion of the total power consumed by the SLIC when the subscriber equipment is in the off-hook state. Those sensing and computational resources can be responsible for the bulk of the SLIC's power consumption when the subscriber equipment is in the on-hook state.

Alternate control mechanisms may be used to control the DC feed when in the on-hook state. For example, analog control loops may be substituted for digital control loops for VBAT and the linefeed driver to reduce the computational resources required. Although analog control loops offer less flexibility than digital control loops, the analog control loops need only be concerned about the limited purpose of ensuring adequate on-hook voltage for the subscriber line for the relevant subscriber equipment.

The linefeed driver and off-hook DC feed control mechanisms also operate to ensure noise levels remain within acceptable limits when the subscriber equipment is off-hook. Other subscriber equipment may share the subscriber line and utilize channels outside of the voiceband. Care must be taken to ensure that the alternate control mechanisms do not result in the contribution of unacceptable noise to the subscriber line. The off-hook and on-hook DC feed control mechanisms are associated with distinct power modes of operation.

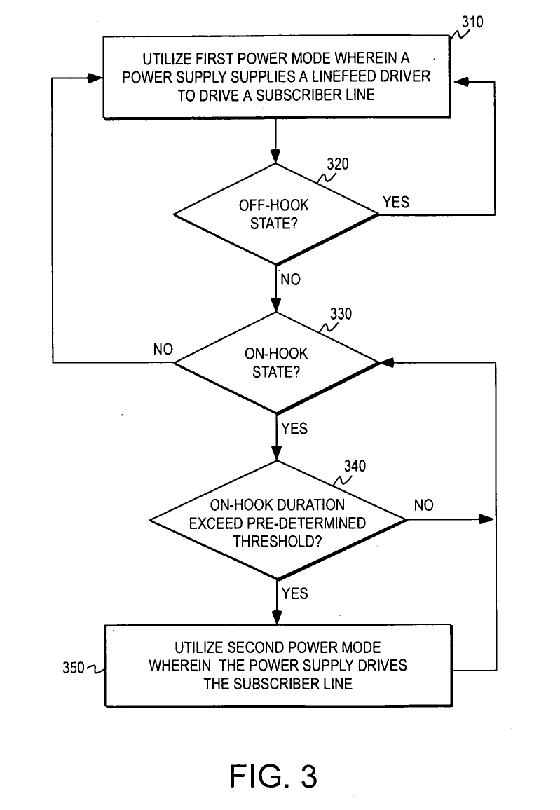

FIG. 3 illustrates one embodiment of a method of providing DC feed to a subscriber line. In step 310, a power supply supplies a linefeed driver to driver a subscriber line utilizing a first power mode. This first power mode is used at least as long as an off-hook state is detected as indicated by step 320.

If an off-hook state is not detected as determined by step 320, then step 330 determines whether an on-hook state exists. If not, utilization of the first power mode continues.

If an on-hook state is detected, then step 340 determines whether the duration of the on-hook state has exceeded a pre-determined threshold. If not, then utilization of the first power mode continues. If so, however, then a second power mode is utilized to control DC feed in step 350. In this second power mode, the power supply provides the subscriber line DC feed.

In summary, the first power mode is utilized whenever the subscriber equipment is off-hook as well as when the subscriber equipment has been on-hook for less than a pre-determined duration of time. A second power mode is used when the subscriber equipment is in the on-hook state and has been in the on-hook state for more than the pre-determined threshold duration of time.

In the second power mode various sensing and computational resources are not needed. In addition, the linefeed driver itself is largely bypassed. Resources that are not needed may be powered down as appropriate to save power. Generally, components performing functions unrelated to off-hook detection can be turned off.

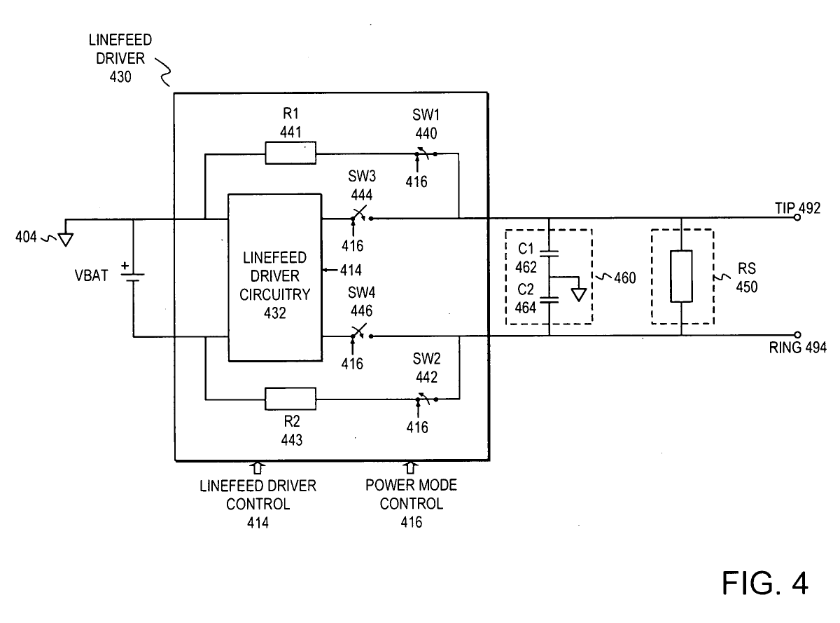

FIG. 4 illustrates one embodiment of a linefeed driver with bypass circuitry for supporting multiple power modes. The bypass circuitry includes switches SW1 440, SW2 442, SW3 444, and SW4 446. The bypass circuitry is controlled by one or more power mode control signals 416.

Switches SW3 444 and SW4 446 permit electrically coupling the linefeed driver circuitry 432 of linefeed driver 430 to the tip 492 and ring 494 lines of the subscriber line. The linefeed driver circuitry 432 provides a DC feed to the subscriber line from VBAT in accordance with the linefeed driver control signals 414.

Switches SW1 440 and SW2 442 permit electrically coupling the VBAT power supply to the tip 429 and ring 494 lines through resistors R1 441 and R2 443, respectively. Although illustrated as distinct components for purposes of discussion, these resistances may implemented as separate resistors or they may be realized as the conduction-resistance of switches SW1, SW2. Regardless, VBAT is coupled to the tip and ring lines through R1 and R2 when switches SW1 and SW2 are conducting.

Switches SW1 and SW2 are controlled in a complementary manner with respect to switches SW3 and SW4. Switches SW3 and SW4 are open when switches SW1 and SW2 are closed. Switches SW3 and SW4 are closed when switches SW1 and SW2 are open. Co-operation among the switches results in a bypass feature where the tip and ring can be driven directly from the power supply or through the controlled linefeed driver circuitry 432.

In one embodiment, SW1, SW2, SW3, and SW4 are incorporated as part of a linefeed driver integrated circuit and reside on a common integrated circuit die with the remainder of the linefeed driver circuitry 432. RS 450 represents the equivalent resistance attributable to the tip/ring sense circuitry utilized by the signal processor.

The supply level for VBAT must also take into account any voltage drop resulting from the resistances associated of switches SW1-SW4 when switching between power modes. In the second power mode, switches SW1 and SW2 are conducting. Resistances R1, R2, and RS form a voltage divider for producing the linefeed from VBAT. The metallic voltage (V_{TIP}−V_{RING}) becomes:

$${V}_{TIP} - {V}_{RING} = VBAT \cdot \frac{RS}{RS + R 1 + R 2}$$

For purposes of illustration, let RS=636 K and R1, R2=30 K such that

$${V}_{TIP} - {V}_{RING} = VBAT \frac{636 K}{636 K + 30 K + 30 K} = 0.914 VBAT$$

Thus VBAT must be increased by

$$\frac{1}{0.914}$$

to provide the desired minimum metallic voltage.

The power supply may be implemented in various ways including battery, charge pumps, and dc-dc converters. Power supplies such as charge pumps and dc-dc converters tend to contribute unwanted noise to the subscriber line. This noise can be problematic for non-POTS communications when the subscriber line is shared.

Numerous communication protocol standards have been developed to enable using the POTS infrastructure for communicating digital data at higher data rates by utilizing a communication bandwidth greater than that of the voiceband. Protocols (xDSL) for digital subscriber line services typically limit their communication spectrum to a range that is not used for voiceband communications. As a result, xDSL services may co-exist with voiceband communications on the same subscriber line.

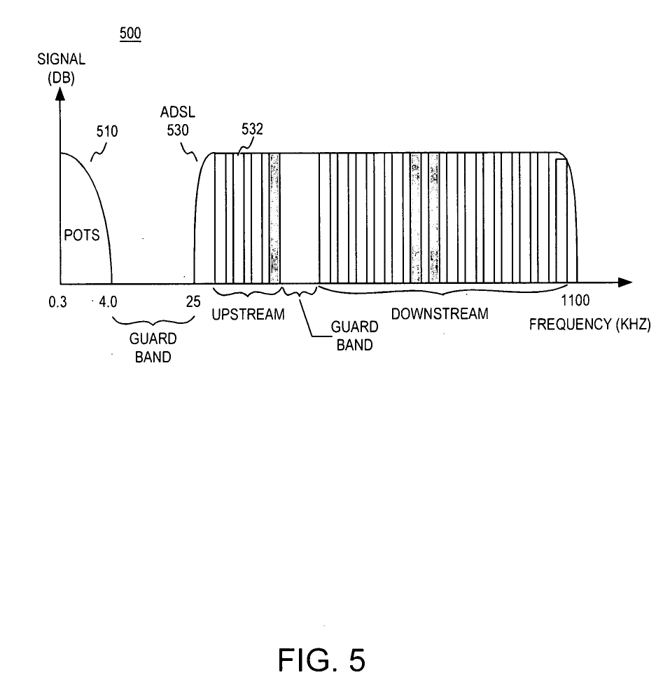

FIG. 5 illustrates one embodiment of communication spectrum allocation for a subscriber line. Chart 500 illustrates the spectrum used for voiceband applications (POTS 510) as well as for one xDSL variant. POTS communications typically use the voiceband range of 300-4000 Hz. One xDSL variant such as asymmetric digital subscriber line (ADSL 530) variant uses frequencies beyond the voiceband in the range of approximately 25-1100 kHz as indicated.

There are multiple line coding or signal modulation techniques for xDSL. xDSL transceivers must perform functions such as near end signal removal, adaptive channel equalization, symbol/bit conversion, timing recovery, and constellation mapping. A modulation technique such as Discrete Multi-Tone (DMT) modulation divides the xDSL communication band into an upstream channel and a downstream channel. Each of these channels is further subdivided into a plurality of sub-channels (532). The sub-channel carriers are individually modulated to communicate information on each of the sub-channels from the transmitter to the receiver. Noise from the power supply can significantly impair the operation of these non-POTS communications.

Referring to FIG. 4, low pass filters serve as the primary mechanism for eliminating unwanted noise when in the second power mode in the illustrated embodiment. The resistances associated with switches SW1 and SW2 when closed (i.e., R1 and R2, respectively) in conjunction with capacitors C1 462 and C2 464 form low pass filters. The values of these components are selected to ensure noise from the power supply is within acceptable limits in the frequency bands associated with other subscriber line services.

For clarification, symbols such as R1, R2, C1, and C2 are used interchangeably to identify a specific component as well as the value of that component. Thus for example, “R1” is used both to identify a specific resistor as well as to represent the resistance value of that resistor.

In one embodiment, the capacitor array 460 resides within the signal processor 120 of FIG. 1. The dotted line is provided to indicate that the array may be located on a same integrated circuit die or within the same integrated circuit package as the remainder of the signal processor. Similarly resistor RS 450 models the equivalent resistance of tip/ring sense circuitry that may be located on a same integrated circuit die or within the same integrated circuit package as the remainder of the signal processor.

The noise contributed by VBAT is filtered by series-coupled capacitors C1 and C2 and the resistors that are in series with the tip and ring lines. RS is presumed to be much greater than R1 or R2 such that the effect of RS on the corner frequency is negligible. Accordingly, the low pass corner frequency f₀ is computed as follows:

$${f}_{0} = \frac{C 1 + C 2}{( R 1 + R 2 ) \cdot C 1 \cdot C 2}$$

In one embodiment, C1=C2 and C1, C2 are selected to be approximately 10 nF such that

$${f}_{0} = \frac{2}{( R 1 + R 2 ) \cdot C 1} = \frac{2}{60 K \cdot 10 nF} = 530 Hz$$

Thus in one embodiment, the SLIC utilizes bypass circuitry and filter circuitry which co-operate in the second power mode to apply a low pass filter to the power supply for each of the tip and ring lines.

The positive terminal of VBAT is coupled to signal ground 404. There should not be significant noise contribution from signal ground. Accordingly, in various embodiments, R1 is dispensed with (i.e., R1=0) such that the tip line is coupled directly to signal ground.

In such a case, the metallic voltage becomes:

$${V}_{TIP} - {V}_{RING} = VBAT \cdot \frac{RS}{RS + R 2}$$

Using the same values as before:

$${V}_{TIP} - {V}_{RING} = VBAT \frac{636 K}{636 K + 30 K} = 0.955 VBAT$$

Thus VBAT must be increased by

$$\frac{1}{0.955}$$

to provide the desired minimum metallic voltage.

If R1=0, the corner frequency is determined exclusively by R2 and C2 as follows:

$${f}_{0} = \frac{1}{R 2 \cdot C 2}$$

Utilizing the same values for R2 and C2 as presented above yields a corner frequency, f₀=530 Hz. Note that this is the same value as obtained when R1=R2. This equality is significant because of the distribution of the components R1, R2, C1, and C2. C1 and C2 are manufactured on the signal processor without regard to the existence of R1. Yet this design ensures that the same corner frequency is achieved irrespective of whether R1 exists in the linefeed driver 430.

Referring again to FIG. 4, the DC feed for the tip and ring lines is provided by the power supply rather than via linefeed driver circuitry 432 while in the second power mode. The linefeed driver circuitry is bypassed. Thus the linefeed driver circuitry may be powered down where possible during the second power mode. The linefeed driver control signals 414 have no bearing on the tip and ring. Accordingly, the signal processor may power down elements or suspend processes providing the linefeed driver control signals.

With respect to the power supply, greater power savings may be achieved by likewise utilizing different supplies in different power modes. The power supply associated with the second power mode must supply a VBAT of approximately 48 VDC but very little current. In particular, a 10 mW-rated supply might be adequate. In contrast, the power supply associated with the first power mode must likewise provide approximately 48 VDC with a minimum threshold of 20 mA for the off-hook state. This implies a minimum power rating of 960 mW. Utilizing the same supply for both the first power mode and the second power mode may cause power-wasting inefficiencies at the 10 mW level of the second power mode. Accordingly, each power mode may be associated with the utilization of a power supply specific to that power mode to avoid power-wasting inefficiencies.

In one embodiment, the power supply is a DC-DC converter utilizing a digital feedback control loop while in the first power mode and an analog feedback control loop while in the second power mode. In an alternative embodiment, a first DC-DC converter is used while in the first power mode and a second DC-DC converter is used while in the second power mode.

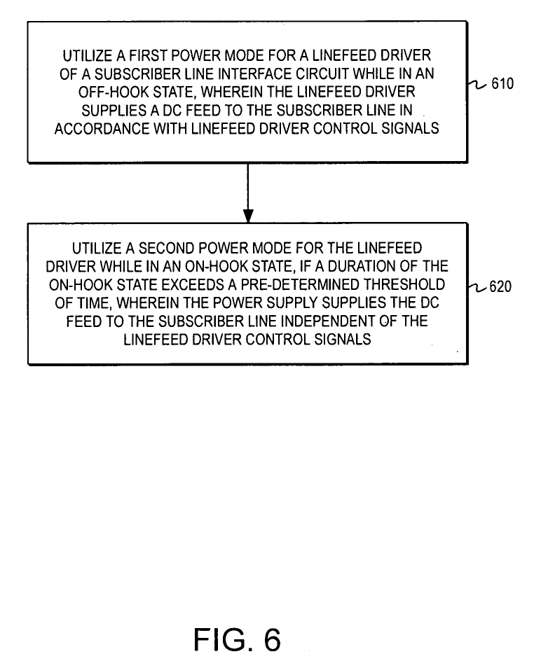

FIG. 6 illustrates one embodiment of a method of providing DC feed to a subscriber line. A first power mode is utilized for a linefeed driver of a subscriber line interface circuit while in an off-hook state. The linefeed driver supplies a DC feed to the subscriber line in accordance with linefeed driver control signals in step 610. A second power mode is utilized for the linefeed driver while in an on-hook state, if a duration of the on-hook state exceeds a pre-determined threshold of time. The power supply supplies the DC feed to the subscriber line independent of the linefeed driver control signals in step 620.

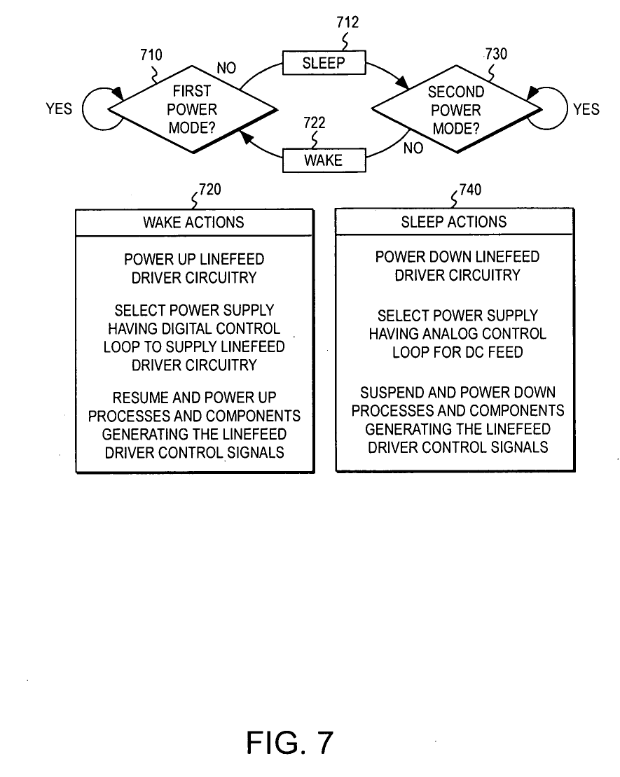

FIG. 7 illustrates one embodiment of a method of transitioning between power modes. The power mode may be determined by a power mode control signal such as signal 416 of FIG. 4. Step 710 determines whether the first power mode is active. If not, then a sleep function 712 triggers or accompanies the transition from the first power mode to the second power mode. Exemplary actions performed by the sleep function are set forth in table 740. Step 730 determines whether the second power mode is active. If not, then a wake function 722 triggers or accompanies the transition from the second power mode to the first power mode. Exemplary actions performed by the wake function are set forth in table 730.

The power mode control signal is set to indicate the first power mode when the impedance across tip and ring falls below 3K. The power mode control determines the switch couplings for the bypass circuitry. In addition, a transition in power mode triggers the wake function. The type of actions that may be associated with a wake function include powering up the linefeed driver circuitry, selecting a power supply having a digital control loop to supply linefeed driver circuitry, and resuming and powering up processes and components for generating the linefeed driver control signals.

Although a transition above the 3K threshold indicates an on-hook status, the power mode control signal is not set to indicate the second power mode until the duration of the on-hook status exceeds a pre-determined time threshold. Until the power mode control is set to indicate the second power mode, the first power mode is in effect—even during the on-hook state. Once the requisite time has elapsed in the on-hook state, the power mode control signal is set to indicate the second power mode. The transition in power mode triggers the sleep function. The type of actions that may be associated with a sleep function include powering down the linefeed driver circuitry, selecting a power supply having an analog control loop to supply the subscriber line DC feed, and suspending and powering down processes and components for generating the linefeed driver control signals.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A subscriber line apparatus, comprising:
linefeed driver circuitry for providing a DC feed for a tip line and a ring line of the subscriber line from a power supply in accordance with linefeed driver control signals; and
bypass circuitry for coupling the tip and ring lines to the power supply in accordance with a power mode control, wherein in a first power mode the tip and ring lines are coupled to the power supply through the linefeed driver circuitry, wherein in a second power mode the linefeed driver circuitry is bypassed to couple the tip and ring lines to the power supply.

2. The apparatus of claim 1 wherein the linefeed driver circuitry and bypass circuitry form a linefeed driver, wherein the linefeed driver circuitry and bypass circuitry reside on a common integrated circuit die.

3. The apparatus of claim 1 wherein the bypass circuitry comprises first and second switches for selectively coupling the tip and ring lines to the power supply, wherein the bypass circuitry comprises third and fourth switches for selectively coupling the tip and ring lines to the linefeed driver circuitry, wherein the operation of the first and second switches is complementary to the operation of the third and fourth switches.

4. The apparatus of claim 3 wherein the first switch couples the tip line to one terminal of the power supply through a resistance value of R1, wherein the second switch couples the ring line to one terminal of the power supply through a resistance of R2.

5. The apparatus of claim 1 further comprising:
a capacitor array of series-coupled capacitors C1 and C2, wherein a first terminal of each of C1 and C2 is coupled at a common signal ground, wherein a second terminal of C1 is coupled to the tip line, wherein a second terminal of C2 is coupled to the ring line.

6. The apparatus of claim 5 further comprising:
a signal processor, wherein the linefeed driver circuitry and bypass circuitry reside on a common first integrated circuit die forming a linefeed driver, wherein the signal processor resides on a separate second integrated circuit die, wherein the capacitor array is formed on the second integrated circuit die.

7. The apparatus of claim 4 further comprising:
a capacitor array of series-coupled capacitors C1 and C2, wherein a first terminal of each of C1 and C2 is coupled at a common signal ground, wherein a second terminal of C1 is coupled to the tip line, wherein a second terminal of C2 is coupled to the ring line.

8. The apparatus of claim 7 wherein R1, R2 are approximately 30K, wherein C1, C2 are approximately 10 nF.

9. The apparatus of claim 1 further comprising a capacitor array, wherein the bypass circuitry and capacitor array co-operate to couple the power supply to each of the tip line and the ring line via a low pass filter.

10. The apparatus of claim 1 further comprising a capacitor array, wherein the bypass circuitry and capacitor array co-operate to form a low pass filter, wherein the power is coupled to one of the tip and the ring line through the low pass filter.

11. A method comprising:
utilizing a first power mode for a linefeed driver of a subscriber line interface circuit while in an off-hook state, wherein the linefeed driver supplies a DC feed to the subscriber line in accordance with linefeed driver control signals; and
utilizing a second power mode for the linefeed driver while in an on-hook state, if a duration of the on-hook state exceeds a pre-determined threshold of time, wherein the power supply supplies the DC feed to the subscriber line independent of the linefeed driver control signals.

12. The method of claim 11 comprising:
filtering the power supply with a low pass filter for each of a tip and a ring line of the subscriber line while in the second power mode.

13. The method of claim 11 comprising:
filtering the power supply with a low pass filter for only one of the tip and ring line of the subscriber line while in the second power mode.

14. The method of claim 11 wherein while in the second power mode circuitry for generating the linefeed driver control signals is powered down.
